(19) United States
(12) Patent Application Publication
(10) Pub. No.: US 2006/0248097 A1
(43) Pub. Date: Nov. 2, 2006

(54) Creating customisable applications

(76) Inventors: John Pritchard, Leonardo, NJ (US); Olivier Poupeney, Massy (FR)

Correspondence Address: HARNESS, DICKEY & PIERCE, P.L.C., P.O. BOX 828, BLOOMFIELD HILLS, MI, 48303, US

(21) Appl. No.: 11/243,526

(22) Filed: Oct. 4, 2005

(30) Foreign Application Priority Data
May 2, 2005 (FR) 0504449

(51) Int. Cl. G06F 7/00

(52) U.S. Cl. 707/100

(57) ABSTRACT

This invention relates to a method for creating an application that corresponds to a set of components, whose execution provides a tailored result according to the usage conditions of the application. The method includes the generation of a set of DOM-type XML documents that include the non-generic logic of the application; the generic logic is associated to Java classes related to certain elements in the DOM. The method according to the invention allows users, in a completely original manner, to easily modify the application without having to recompile all the executables.

### CROSS REFERENCE TO RELATED APPLICATION

This application claims priority to French Application No. 0504449, filed May 2, 2005, which is incorporated by reference herein.

### BACKGROUND AND SUMMARY OF THE INVENTION

This invention relates to the field of creating computer applications, in particular, customisable applications. More specifically, this invention relates to a method for creating customisable applications whose display can depend on the conditions of use and the identity or profile of the user.

Being able to customise the way applications are displayed for different users is an advantage. For example, a user might want to only display one type of content data for a first type of customer, and display a second type of content data for a second type of customer. In addition, users might want to vary the way this same content is displayed.

The previous art had already offered a technical solution to this same problem of customisation by suggesting an architecture in the form of a structured data source, such as a relational or XML database that includes the definition and the data relative to the customisation data, as well as links between each type of data element (i.e.: profile, page, etc.) The various application components, for example, java type components, allow displaying customised pages by invoking an application programming interface (API) composed of a set of object classes that encapsulate access to the data source, and recovering the customisation data, which are then processed and sent to the application components in the form of a customised result. FIG. 1 describes such a solution of the previous art, in which customisation is performed by invoking java classes that contain the specific code and a data source (for example, a relational database type source.) This database includes customisation data that is used to provide a customised result according to the user, A or B.

During operation, an application component, a Web component for example, invokes a Java class using the parameters associated to user A. This class can be guided by an ancestor Java class that encapsulates the generic logic. The logic of the Java class therefore manages a set of requests and responses from the data source that contains the customisation information and processes this information in order to obtain a personalised result A.

It is important to understand that in this type of configuration, the specific and generic java programs referring to the application programming interface are compiled, and the addition or modification of a new customisation attribute in the database requires not only updating and migrating existing information, but also modifying and recompiling the API java code. In this case, it is also necessary to modify and recompile all the programs that use the API. More specifically, if the data source structure is modified, and the references between data elements are changed, the java classes that contain the non-generic logic related to this data must also be changed in order to take into account the new information and, therefore, recompile the classes. It is understood that this constraint constitutes an inconvenience in the development of the tool that allows generating customisable applications. This inconvenience is resolved by the method and the computer program such as they are claimed.

According to the invention, a method for creating an application is provided, which corresponds to a set of components and whose execution provides a tailored result according to the usage conditions of said application, including:
An initial preliminary stage for creating an application and that consist in:
Defining an initial set of XML documents whose nodes represent said usage conditions;
Defining a second set of XML documents whose nodes represent the components of said application;
Each of said first and second set comprising XML documents including an first type of node related to an executable and a second type of node that defines a reference to an XML document of said first and second set of documents;
The documents of the second set including a third type of node that defines a reference to an XML document of the second set and representing a component of the same type;
A second execution stage of said application, which consists in:
Using an interpreter to read a document of the second set for interpreting all of its nodes and the nodes of the referenced documents of said first and second set; the interpretation of each node of the first type allowing the execution of said related executables;
Storing, in an application context, the results of the executions of said executables;
Providing the contents of said application context.

The invention also relates to a computer program that may be stored on a data medium for implementing the procedure according to the invention. According to the invention, the set of the specific logic that was present in the Java classes compiled according to the previous art is now obtained in the form of a DOM (Document Object Model) that therefore performs an XML-type program.

### BRIEF DESCRIPTION OF THE DRAWINGS

The invention will be better understood by reading the description, provided hereafter solely as an explanation of an embodiment of the invention, whilst referring to the attached Figures:

FIG. 1 illustrates the customisation procedure and architecture according to the previous art.

FIG. 2 illustrates the customisation procedure and architecture according to the invention.

FIG. 3 represents a specific example of a customisation DOM according to the invention.

FIGS. 4a to 4c correspond to an example of XML code for implementing this invention.

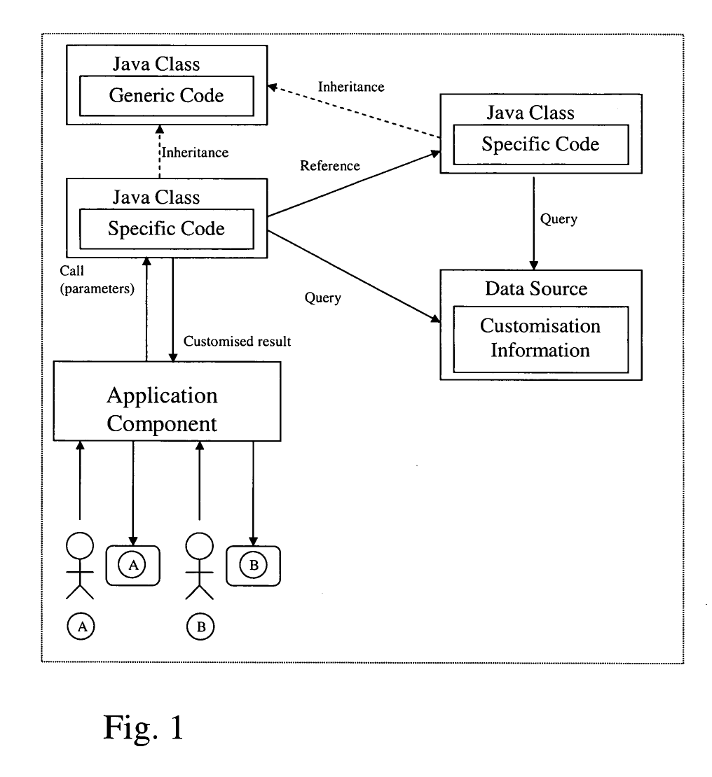

### DETAILED DESCRIPTION

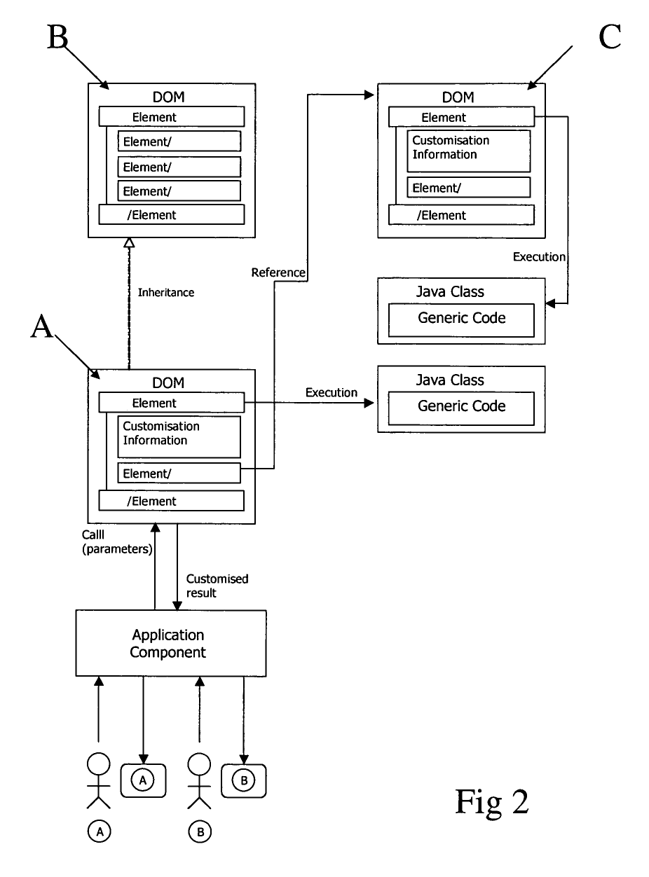

As illustrated in FIG. 2, according to the invention, a set of DOM A is defined, with nodes representing the elements that correspond to the presentation data. This DOM A therefore includes elements that represent the non-generic logic for the customisation information INFO that it defines.

Firstly, it can be noted that in all that follows, the notion of inheritance is employed in the sense known by those skilled in the art in the area of programming, for example, the inheritance of object classes (i.e., java.) This first DOM A therefore inherits a second type of DOM B. Each element of DOM A therefore includes either all the customisation information required for customisation, or only part of this information; the information details are known in the DOM B that it inherits. Furthermore, the DOM A elements can reference other DOM C in the sense of the XML reference in order to complete the information elements necessary for customisation.

Each type of element representing the DOM nodes according to the invention reference a Java class that contains a generic logic. A specific interpreter then interprets the elements in order to invoke the correct Java class. Therefore, it can be easily understood that this data structure allows, when the customisation attributes are to be modified, preventing the need to recompile the Java class included in the non-generic code, and simply adding a DOM or element that references a DOM that includes the information to be added.

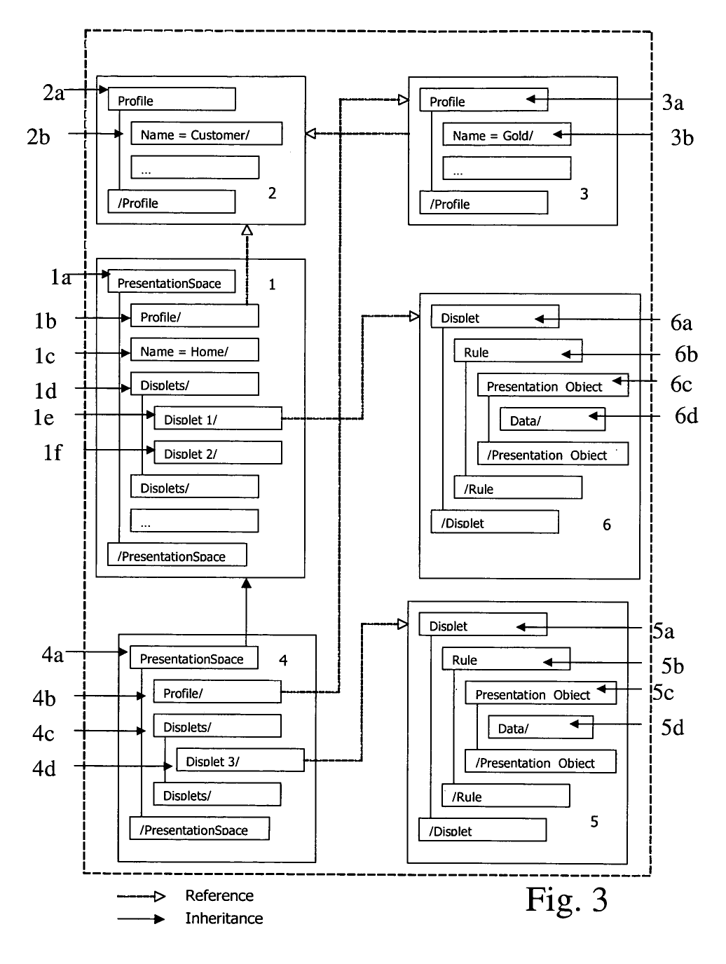

Now, the invention will be specifically described in the framework of a profile as illustrated in FIG. 3. The reference 1 DOM includes a “Presentation Space” element that corresponds to the different presentation data of a page. This DOM 1 includes a “Profile” element 1b that references a DOM 2 that includes a “Profile” type element 2a with the name “Customer” 2b. This profile corresponds, for example, to the default customer type.

When a “Customer” type user connects, and at the moment of interpretation of the DOMs, the reference between DOM 1 and 2 allows invoking, for this type of customer, the “displet” type elements 1d, 1e, and 1f and displaying the “Displet 1” and “Displet 2” displets as defined in DOM 1. This display is performed by executing a Java class related to, for example, “Presentation Object” type elements 6c of the Displet element 6a of DOM 6.

Suppose now that a specific “Gold” type customer is defined, by creating a new DOM 3 that includes a “Profile” type element 3b with the name “Gold,” and the user wants to associate a specific display of a “Displet 3” displet to this type of customer. In this case, another DOM 4 is created, which includes a “Presentation Space” type element 4a that, on the one hand, inherits from DOM 1 displets 1 and 2 in order to also display them for the “Gold” customer, and on the other hand, includes a “Profile” type element 4b that references DOM 3. This way, during interpretation, the “Displet 3” displet will be displayed for “Gold” type customers but not for “Customer” type customers.

Therefore, from this, it can be understood that in order to add a profile with specific attributes, there is no need to modify the structure of the information related to the profiles and recompile existing classes. Rather, a new DOM can be created that inherits existing DOMs for the type of modification to be performed and a new profile corresponding to the profile to be added is referenced.

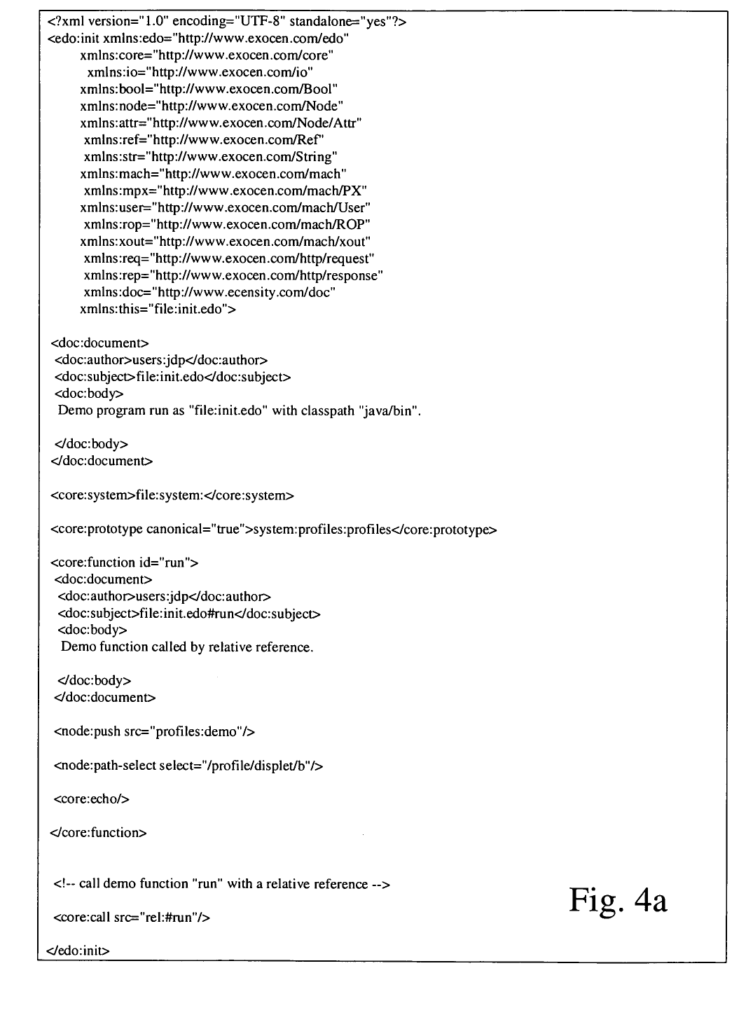

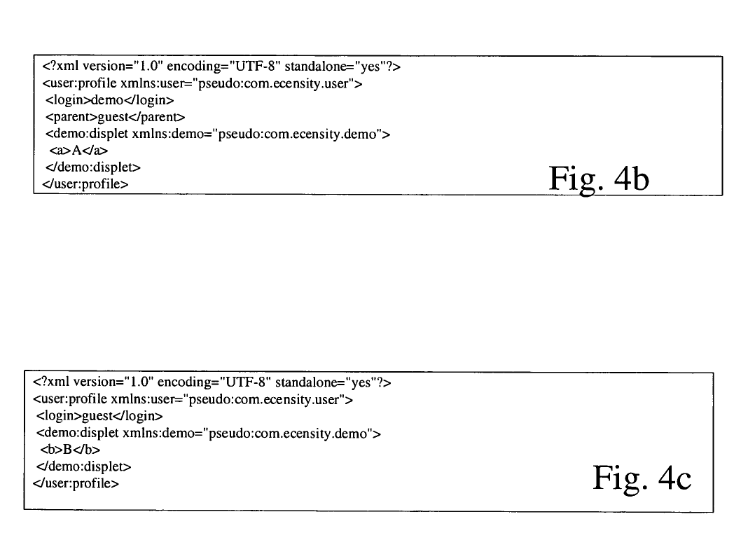

FIGS. 4a to 4c illustrate an example of code related to the situation described in FIG. 3. FIG. 4a corresponds to a DOM type application component that assigns the “Demo” type profile to the current user, and therefore according to the invention, makes reference to the “Demo” DOM in FIG. 4b, using the instruction <node:push src=“profiles:demo”/>. We then look for the value of the displet element b for the “Demo” profile. The instruction <node:push src=“profiles.demo”/> puts the information regarding the “Demo” profile into the context. The instructions <node:path-select select=“profile/displet/b”/> and <core:echo/> select the displet/b element and display it for the “Demo” profile.

FIG. 4b, because of the “Parent” node, there is a reference to the “Guest” DOM that contains the displet/b element. The interpreter will therefore build the context by placing the “Demo” profile information (DOM in FIG. 4b) and adding to it the information of its “Guest” parent profile (DOM in FIG. 4c.) In the DOMs in FIGS. 4a to 4c, each “displet” type node invokes a java executable, which processes the information.

Those skilled in the art will understand in this example the advantage of the invention. Indeed, if the users want to add a “Demo2” profile, they simply create the “demo2” DOM and modify the references in the initial DOM in FIG. 4a, without modifying the related Java class. The invention is described above for illustrative purposes. It is understood that those skilled in the art can perform different variants of the invention within the scope of the patent.

1. A method for creating an application corresponding to a set of components, whose execution provides a tailored result according to the usage conditions of said application, the method comprising:
(a) an initial preliminary stage for creating an application and that further comprises:
defining an initial set of XML documents whose nodes represent said usage conditions;
defining a second set of XML documents whose nodes represent the components of said application;
each of said first and second set comprising XML documents including an initial type of node related to an executable and a second type of node that defines a reference to an XML document of said first and second set of documents;
the documents of the second set including a third type of node that defines a reference to an XML document of the second set and representing a component of the same type;
(b) a second execution stage of said application, which further comprises:
using an interpreter to read a document of the second set for interpreting all of its nodes and the nodes of the referenced documents of said first and second set; the interpretation of each node of the first type allowing the execution of said related executables;
storing, in an application context, the results of the executions of said executables; and
providing the contents of said application context.

2. The method according to claim 1, wherein said executable is a Java class.

3. The method according to claim 1, wherein said execution is performed on a server.

4. The method according to claim 1, wherein said execution is performed on a client station.

5. The method according to claim 1, wherein said usage conditions correspond to a user profile.

6. A computer program comprising a set of instructions for implementing the procedure according to claim 1.
